(19) United States
(12) Patent Application Publication
(10) Pub. No.: US 2023/0107860 A1
(43) Pub. Date: Apr. 6, 2023

(54) SPRAY GUN, PRESSURE MEASURING DEVICE FOR A SPRAY GUN AND METHOD FOR DEVELOPING A SPRAY GUN

(71) Applicant: SATA GmbH & Co. KG, Kornwestheim (DE)

(72) Inventor: Norbert MAIER, Allmersbach i.T. (DE)

(73) Assignee: SATA GmbH & Co. KG, Kornwestheim (DE)

(21) Appl. No.: 17/908,959

(22) PCT Filed: Feb. 18, 2021
(86) PCT No.: PCT/EP2021/054061

§ 371 Date: Sep. 2, 2022

(30) Foreign Application Priority Data
Mar. 6, 2020 (DE) 10 2020 106 173.0

(51) Int. Cl. B05B 12/00; B05B 7/06; B05B 7/08; B05B 7/24

(52) U.S. Cl. CPC B05B 12/008; B05B 7/066; B05B 7/0815; B05B 7/2478

(57) ABSTRACT

A spray gun, in particular a pressurised air atomisation paint spray gun, in particular a hand-held pressurised air atomisation paint spray gun has at least one material nozzle for discharging a material to be sprayed, at least one air nozzle for outputting air, in particular air for atomising a material to be sprayed, air for changing the shape of a spray jet, and/or air for transporting an atomised spraying medium, and at least one air chamber, in particular an air chamber adjoining the air nozzle or at least one air outlet opening of the air nozzle in the upstream direction, for supplying the air nozzle with air. The spray gun also has at least one device for inputting and/or adjusting and/or detecting and/or determining and/or displaying the air pressure in the air chamber during operation of the spray gun.

The invention relates to a spray gun, in particular a paint spray gun, in particular a hand-held pressurized air atomization paint spray gun, according to the preamble of claim 1, to a pressure measuring device for a spray gun, in particular for a hand-held pressurized air atomization paint spray gun, according to the preamble of claim 11, and to a method for designing a spray gun, in particular a hand-held pressurized air atomization paint spray gun, according to the preamble of claim 15.

Spray guns, in particular paint spray guns, operate using various pressurizing methods. Conventional spray guns operate at relatively high spray pressures of several bar. In so-called HVLP guns, the internal nozzle pressure is at most 10 psi or 0.7 bar, as a result of which transmission rates of far beyond 65% are achieved. Compliant spray guns, in turn, have an internal nozzle pressure of more than 10 psi or 0.7 bar, but likewise achieve a transmission rate of more than 65%.

The internal nozzle pressure of the spray gun is understood to mean the pressure that prevails in the air cap of the spray gun. The atomization air region here is often separated from the horn air region and a different pressure may prevail in the atomization air region than in the horn air region. However, the pressures in the atomization air region and in the horn air region may also be identical.

According to the prior art, a spray gun, in particular a paint spray gun, in particular a pressurized air atomization paint spray gun, on the head thereof has a paint nozzle which is screwed into the gun body. The paint nozzle on the front end thereof often has a hollow-cylindrical plug, the material to be sprayed exiting the front port of said plug during the operation of the spray gun. However, the paint nozzle in the front region thereof can also be of a conical design. The gun head usually has an external thread by way of which an annular air nozzle having an air cap disposed therein is screwed to the gun head. The air cap has a central opening with a diameter larger than the external diameter of the paint nozzle plug, or the external diameter of the front end of a conical paint nozzle, respectively. The central opening of the air cap and the plug, or the front end of the paint nozzle, respectively, conjointly form an annular gap. The so-called atomization air, which in the nozzle assembly described above generates a negative pressure on the end face of the paint nozzle, as a result of which the material to be sprayed is suctioned out of the paint nozzle, exits this annular gap. The material to be atomized is fed to the atomization air and shredded so as to form threads and strips. These threads and strips disintegrate by virtue of their hydrodynamic instability, the interaction between the rapidly flowing compressed air and the ambient air, as well as by virtue of aerodynamic disturbances, to form droplets which are blown away from the nozzle by the atomization air.

The air cap furthermore often has two horns which are diametrically opposed and in the outflow direction project beyond the annular gap mentioned and the material outlet opening. Two supply bores, i.e. horn air feed ducts, run from the rear side of the air cap to horn air bores in the horns. Each horn usually has at least one horn air bore; however, each horn preferably has at least two horn air bores from which the horn air exits. The horn air bores are usually oriented such that said horn air bores point toward the nozzle longitudinal axis behind the annular gap in the exiting direction, so that the so-called horn air exiting the horn air bores can influence the air that has already exited the annular gap, or the paint jet or the paint mist which has already been at least partially created, respectively. As a result, the paint jet, or else the spray jet, with an originally circular cross section (round jet) is compressed on the sides of said jet that face the horns and is elongated in the direction perpendicular thereto. Created as a result is a so-called broad jet which permits a high surface painting rate. Besides deforming the spray jet, the horn air causes further atomization of the spray jet.

Air ducts are usually incorporated in the gun body, i.e. the main body of the spray gun, wherein air from one of the ducts, as described above, for use as atomization air is directed to the annular gap mentioned, and air from another duct, as described above, for use as horn air is directed to the horn air openings mentioned. To this end, the air ducts open out in an end face of the head of the gun body and by way of an air distributor assembly are directed to the annular gap, or the horn air bores, respectively. The air distributor assembly often comprises an air distributor ring which separates the atomization air region and the horn air region from one another.

The air pressure in the spray gun, in particular in the air chamber for supplying the above-mentioned annular gap for delivering atomization air, said air chamber often being formed by the air cap and the material nozzle, or else in the horn air supply ducts, or the horn air bores in the horns, respectively, is one of the most decisive criteria for a high-quality painting result, in particular for the quality of the atomization of the material to be sprayed.

For this reason, DE 10135104 C1 proposes to provide a pressure detection and pressure display device 45 in a paint spray gun, wherein the paint spray gun has a paint nozzle 11 disposed on a gun body 1, an air nozzle 21 disposed about the paint nozzle 11, a compressed air valve 31, 32 for controlling the supply of compressed air to the air nozzle 21 and which is disposed within a piston bore 33 in the gun body 1, a compressed air bore 36 which runs through a handle 2 of the gun body 1 to the piston bore 33, and a pressure detection and pressure display device 45 disposed in the handle 2, wherein a tube 38 is disposed in the compressed air bore 36 so as to be spaced apart from the internal wall of the latter, said tube 38 in the interior forming a duct 53 for the supply of compressed air to a part of the piston bore 33 that is disposed upstream of the compressed air valve 31, 32 and between the external side of said tube 38 and the internal wall of the compressed air bore 36 delimiting an intermediate space 39 which by way of a first connection duct 50 is connected to a pressurized chamber 28 disposed downstream of the compressed air valve 31, 32 and by way of a second connection duct 52 is connected to a pressure measuring chamber 46 in the handle 2, which pressure measuring chamber 46 is assigned to the pressure detection and pressure display device 45. As opposed to the earlier prior art, it should be possible by means of this solution to not only measure the input pressure but to measure the spray pressure.

DE 10 2009 020 194 A1 discloses a spray gun having a gun body 1, a nozzle assembly 9 disposed on the gun body 1, a compressed air supply duct 22, 23 which is disposed in the gun body 1 and has a valve assembly 17 for controlling the supply of compressed air to the nozzle assembly 9, a device 31, 33, 37, 42, 40 for regulating the supply of compressed air, and a pressure measuring device 35 for detecting and displaying the pressure in the compressed air supply duct 22, said spray gun being characterized in that the pressure measuring device 35 is removably fastened to the device 31, 33, 37, 42, 40 for regulating the supply of compressed air. As a result, it should be made possible that the pressure measuring device is not contaminated or damaged during cleaning work, and a battery change, which is necessary when using a digital pressure gauge, is easy to carry out.

The solutions have proven successful for many years. Nevertheless, only an approximate measurement of the actual spray pressure is possible by means of the solutions.

It is therefore a first object of the present invention to provide a spray gun, in particular a pressurized air atomization paint spray gun, in particular a hand-held pressurized air atomization paint spray gun, in which the actual spray pressure can be determined more accurately than in the prior art.

It is a further object of the present invention to provide a pressure measuring device for a spray gun, in particular for a hand-held pressurized air atomization paint spray gun, by means of which the actual spray pressure of a spray gun can be determined more accurately than in the prior art.

It is a further object of the present invention to provide a method for designing a spray gun, in particular a hand-held pressurized air atomization paint spray gun, by means of which the actual spray pressure can be determined more accurately than in the prior art.

The first object is achieved by means of a spray gun, in particular by means of a pressurized air atomization paint spray gun, in particular by means of a hand-held pressurized air atomization paint spray gun, which has at least one material nozzle for delivering a material to be sprayed, at least one air nozzle for delivering air, in particular air for atomizing a material to be sprayed, air for changing the shape of a spray jet, and/or air for transporting an atomized spray medium, and at least one air chamber, in particular an air chamber which upstream is adjacent to the air nozzle or to at least one air outlet opening of the air nozzle, for supplying the air nozzle with air, wherein the spray gun furthermore has at least one device for entering and/or adjusting and/or detecting and/or determining and/or displaying the air pressure prevalent in the air chamber during the operation of the spray gun.

The spray gun can be in particular a flow-cup gun, a hanging-cup gun, a side-cup gun or a pressure-fed gun. The spray gun can in particular be able to be used for spraying liquid media, in particular paint or lacquer.

The air chamber for supplying the air nozzle with air upstream being adjacent to the air nozzle or to at least one air outlet opening of the air nozzle presently means that the air chamber is situated directly behind the air nozzle and that the air that flows out of the air chamber flows directly through the at least one air outlet opening of the air nozzle. The air chamber is not completely closed, but has at least one air entry and – in the form of the air nozzle, or the air outlet opening of the air nozzle, respectively – at least one air exit. The air chamber can be formed solely by one component of the spray gun or by a plurality of components. In particular, the air chamber can be formed by the air nozzle; for example, the air chamber can be designed as a milled cutout or a bore in the air nozzle. The air chamber in general is preferably a cavity which upstream is directly adjacent to an air outlet opening in the air nozzle. Upstream presently means counter to the air flow. More than one air chamber may be present, in particular two, three or four air chambers may be present. In particular, at least one air chamber can be present for air for atomizing a material to be sprayed, at least one air chamber, preferably two air chambers, can be present for air for changing the shape of a spray jet, and/or at least one air chamber can be present for air for transporting an atomized spray medium. The air chambers upstream preferably are adjacent to the respective air outlet opening that ensures that the respective air is exhausted. That is to say that an air chamber for air for atomizing a material to be sprayed upstream is adjacent to the air outlet opening for exhausting atomization air, the air chamber for air for changing the shape of a spray jet upstream is adjacent to the air outlet opening for exhausting forming air, and/or the air chamber for air for transporting an atomized spray medium upstream is adjacent to the air outlet opening for exhausting transport air.

The air pressure prevalent in the air chamber during the operation of the spray gun is in particular the so-called internal nozzle pressure. This here is in particular the relative pressure using the ambient pressure as a reference variable. Operation of the spray gun is to be understood that at least the air valve of the spray gun is opened so that air, in particular compressed air, can flow from an air inlet of the spray gun into the air chamber and to at least one air outlet opening of the spray gun. This state is in most instances achieved by slightly activating the trigger of the spray gun. If the trigger is further activated, the flow of the material to be sprayed is thus also activated, in particular by way of the paint needle exiting the material outlet opening of the material nozzle. This state is presently also considered to be operation of the spray gun.

The at least one device for entering and/or adjusting and/or detecting and/or determining and/or displaying the air pressure prevalent in the air chamber during the operation of the spray gun can be designed in many ways. A plurality of identical and/or a plurality of different devices may be provided, which can also be combined with one another and/or connected to one another, in particular connected to one another in a communicating manner.

A device for entering and/or adjusting the air pressure prevalent in the air chamber during the operation of the spray gun can serve for establishing a specific target value for the air pressure, or for communicating said target value to a control and/or feedback-controlled device, respectively. The device for entering and/or adjusting the air pressure prevalent in the air chamber during the operation of the spray gun can be designed, for example, as a keyboard, a touch display, a rotary button, an array of buttons, a selector lever, or have means of such type. The device for entering and/or adjusting the air pressure prevalent in the air chamber during the operation of the spray gun can be disposed within or on the spray gun; the device for entering and/or adjusting the air pressure prevalent in the air chamber during the operation of the spray gun, or a further device for entering and/or adjusting the air pressure prevalent in the air chamber during the operation of the spray gun, can however also be disposed outside the spray gun.

A device for detecting the air pressure prevalent in the air chamber during the operation of the spray gun can serve for measuring an actual value of the air pressure and optionally for communicating said actual value to a control and/or feedback-controlled device and/or to a device for displaying the air pressure prevalent in the air chamber during the operation of the spray gun. The device for detecting the air pressure prevalent in the air chamber during the operation of the spray gun can be designed, for example, as a pressure measuring device, in particular as a pressure sensor. For example, the pressure sensor can be designed as an absolute pressure sensor, as a differential pressure sensor or as a relative pressure sensor. A combination of a plurality of sensors or pressure measuring devices of the same type and/or of different types can also be advantageous. For example, piezoresistive pressure sensors, piezoelectric pressure sensors, capacitive pressure sensors and/or inductive pressure sensors may be used.

A device for determining the air pressure prevalent in the air chamber during the operation of the spray gun differs from the device for detecting the air pressure prevalent in the air chamber during the operation of the spray gun in that the air pressure prevalent in the air chamber is not measured directly by the device for determining the air pressure prevalent in the air chamber during the operation of the spray gun, as opposed to the device for detecting the air pressure prevalent in the air chamber during the operation of the spray gun, but is determined, in particular computed, from other parameters. For example, an air pressure prevalent outside the air chamber, in particular an air pressure prevalent outside the air chamber but within the spray gun, in particular an air pressure prevalent outside the air chamber but within the spray gun during the operation of the spray gun, in particular a gun input pressure, a temperature, a flow rate, a volumetric flow, a position of an add-on part and/or of an operating part of the spray gun, such as, for example, of a trigger and/or of a rotary button, a dimension of at least one part of the spray gun, in particular of an air cap and/or of a material nozzle, and/or another parameter can be utilized for determining the air pressure prevalent in the air chamber during the operation of the spray gun. In order for these parameters to be determined, measuring devices, in particular sensors, such as, for example, pressure measuring devices, in particular pressure sensors, temperature measuring devices, in particular thermometers or temperature probes, respectively, flow measuring apparatuses, in particular flow sensors or flow rate sensors, respectively, in particular flow rate sensors functioning by means of an impeller, vortex or ultrasound and/or thermal flow rate sensors, flow meters or anemometers, position measuring devices, in particular sensors or detectors for measuring positions, respectively, which are also referred to as travel sensors, distance sensors, position sensors or displacement sensors, or else proximity switches or proximity sensors, respectively, can be used. Some of the parameters, for example a nozzle size, can however also be entered by way of an input device which can be designed, for example, as a keyboard, a touch display, a rotary button, an array of buttons, a selector lever, or have means of this type. The input device can however also be designed as an identification and/or data detection apparatus, such as, for example, as a barcode scanner or RFID scanner.

A device for displaying the air pressure prevalent in the air chamber during the operation of the spray gun can serve for displaying an actual value and/or a target value for the air pressure. This is preferably an electrical or electronic display, in particular a screen or a display, in particular an LCD or OLED display, which is particularly preferably disposed in the main body of the spray gun. However, this can also be a mechanical or electromechanical display.

The devices mentioned can be connected to one another, in particular connected to one another in a communicating manner. The communication between devices can take place, for example, by means of cables or wires or wirelessly, for example by radio, satellite, Bluetooth, WLAN, ZigBee, NFC, Wibree, WiMAX, LoRaWAN and/or IrDA.

The second object is achieved by means of a pressure measuring device for a spray gun, in particular for a hand-held pressurized air atomization paint spray gun, in particular for a spray gun described above and further below, wherein the spray gun has at least one material nozzle for delivering a material to be sprayed, at least one air nozzle for delivering air, in particular air for atomizing a material to be sprayed, air for changing the shape of a spray jet, and/or air for transporting an atomized spray medium, and at least one air chamber for supplying the air nozzle with air, wherein the spray gun furthermore has at least one air duct for directing air, in particular compressed air, from an air inlet to the air nozzle, wherein the pressure measuring device has at least one device for detecting an air pressure, in particular a pressure sensor, wherein the pressure measuring device is fastened or fastenable, in particular removably fastened or fastenable, to a spray gun in such a manner that the pressure measuring device is connected to the air duct, and wherein the pressure measuring device furthermore has a device for determining, in particular computing, the air pressure prevalent in the air chamber during the operation of the spray gun based on the air pressure value determined by the device for detecting an air pressure, in particular the pressure sensor.

The air pressure prevalent in the air chamber during the operation of the spray gun is in particular the so-called internal nozzle pressure.

The pressure measuring device may be able to be disposed on the spray gun, for example instead of a device for regulating the air supply, in particular instead of an air micrometer. However, said pressure measuring device can also be disposed on the lower end of the handle of the spray gun, in particular at the air inlet or air connector, respectively. Said pressure measuring device can in particular be designed in a manner similar to the pressure measuring device disclosed in DE 10 2009 020 194 A1.

The third object is achieved by means of a method for designing a spray gun, in particular a hand-held pressurized air atomization paint spray gun, in particular a spray gun described above and further below, wherein the spray gun has at least one air nozzle for delivering air, in particular air for atomizing a material to be sprayed, air for changing the shape of a spray jet, and/or air for transporting an atomized spray medium, and at least one air chamber, in particular an air chamber which upstream is adjacent to the air nozzle or to at least one air outlet opening of the air nozzle, in particular an air chamber formed by a material nozzle of the spray gun and an air cap of the spray gun, for supplying the air nozzle with air, wherein the method comprises at least determining a variance between a first air pressure, which is prevalent at a first position within the spray gun during the operation of the spray gun, and a second air pressure, which is prevalent at a second position within the spray gun during the operation of the spray gun, wherein the first position is situated within the air chamber, and wherein the second position is situated outside the air chamber.

The first air pressure which is prevalent at a first position within the spray gun, wherein the first position is situated within the air chamber for supplying the air nozzle with air, can be measured with the aid of a so-called test air cap, for example. This here is a special air cap which is disposed on the spray gun instead of the customary air cap. The test air cap usually has two manometers, wherein one of the latter by way of a bore in the test air cap is connected to the atomization air region, and the other by way of a further bore in the test air cap is connected to the horn air region. An expedient use of the spray gun is not possible when the test air cap is fitted. The first air pressure can however also be carried out by means of another pressure measuring device which is temporarily disposed on the air nozzle or in the air chamber.

The second air pressure which is prevalent at a second position within the spray gun, wherein the second position is situated outside the air chamber for supplying the air nozzle with air, can be carried out by a pressure measuring device, in particular a pressure sensor, which is likewise temporarily or else permanently disposed at the measuring position.

The variance between the first air pressure and the second air pressure, i.e. the variance between the air pressure within the air chamber and the air pressure outside the air chamber, can in particular be a function of the value of the air pressure, in particular of the value of the second air pressure. In this way, a high air pressure can cause a high variance. The method can provide that at least one characteristic line is recorded which indicates, for example, the first air pressure as a function of the second air pressure and/or of a gun input pressure, and/or indicates the variance between the first air pressure and the second air pressure as a function of the first air pressure and/or of the second air pressure and/or of the gun input pressure. The recording, i.e. in particular the establishment, documentation and/or storage of the characteristic line, can be performed manually or automatically.

A manual recording can take place in such a manner, for example, that the second air pressure is adjusted to a first, for example relatively low, value and the first air pressure is measured and documented. Subsequently, the second air pressure is adjusted to a second value, which is somewhat higher than the first value, and the first air pressure is again measured and documented. Thereafter, the second air pressure is adjusted to a third value, which is again somewhat higher than the second value, and the first air pressure is again measured and documented. This procedure can be repeated until the maximum permissible pressure has been reached. If the measured points in an X-Y diagram, wherein the second air pressure for example is plotted on the X-axis and the first air pressure is plotted on the Y-axis, are connected, a characteristic line which indicates the first air pressure as a function of the second air pressure is obtained.

An automatic recording of the characteristic line can take place in a manner substantially identical to that of the manual characteristic line, wherein the adjustment of the values for the second air pressure and the measurement and documentation of the associated values for the first air pressure are in each case carried out by one or a plurality of devices, in particular carried out in a self-acting manner.

The variances, the series of variances and/or the characteristic line can of course also be obtained by computer simulation methods.

The variance between the first air pressure and the second air pressure, i.e. the variance between the air pressure within the air chamber and the air pressure outside the air chamber, can also depend on other factors, for example on the material nozzle used and/or on the air nozzle used, in particular on the type and/or on at least one dimension of the material nozzle used and/or on the type and/or on at least one dimension of the air nozzle used, in particular the so-called nozzle size, and/or whether the nozzle, or the set of nozzles, respectively, is for example an HVLP nozzle, a compliant nozzle or a conventional nozzle. A dedicated characteristic line is preferably recorded for a plurality, in particular all, of potential nozzles and/or nozzle sets being used, i.e. being able to be disposed in or on the spray gun, respectively. A nozzle set generally consists of a material nozzle, an air nozzle and a paint needle.

If the variance between the first air pressure and the second air pressure, i.e. the variance between the air pressure within the air chamber and the air pressure outside the air chamber, optionally as a function of the value of the air pressure, in particular of the value of the air pressure outside the air chamber, and/or as a function of the nozzle, is known, or if the above-described characteristic line, in particular for a specific nozzle, is known, then it is sufficient for the air pressure outside the air chamber to be measured and the air pressure within the air chamber can be determined, in particular computed, in this way. The determination of the variance, in particular the recording of the characteristic line, preferably takes place by the manufacturer of the spray gun. A device for detecting an air pressure within the air chamber during the operation of the spray gun can thus be dispensed with. As a result, the production of the paint spray gun is simplified and disturbances of the air flow in the air chamber, which could be caused by a device for detecting the air pressure within the air chamber, are prevented.

The method according to the invention can, for example, provide that, in particular by the manufacturer of the spray gun, a first nozzle or a first nozzle set is inserted in the spray gun, a first device for detecting a first air pressure prevalent within the air chamber, in particular a first pressure sensor, is disposed in or on the spray gun, a second device for detecting a second air pressure prevalent outside the air chamber, in particular a second pressure sensor, is disposed in or on the spray gun, wherein the second device for detecting a second air pressure, in particular the second pressure sensor, is disposed in the spray gun in such a manner that said device, or pressure sensor, respectively, is connected to an air duct within the spray gun. Subsequently, it can be provided that the spray gun is fed compressed air, a first air pressure within the air chamber and a second air pressure outside the air chamber are measured, and the variance between the first air pressure and the second air pressure is determined. A characteristic line can in particular be recorded as described above. The series of variances, or the characteristic line, respectively, preferably linked to an item of information pertaining to the inserted nozzle or to the inserted nozzle set, is memorized, in particular stored, in a data processing device which is described in more detail hereunder and can also be considered to be an evaluation unit. This data processing device is, or will be, respectively, connected to the second device for detecting a second air pressure, in particular the second pressure sensor, outside the air chamber. The determination of variances, or the recording of characteristic lines, respectively, is preferably repeated for a plurality of different nozzles or nozzle sets and the series of variances, or the characteristic lines, respectively, again preferably linked to an item of information pertaining to the respective nozzle inserted or the respective nozzle set inserted, are memorized, in particular stored, in the data processing device. Finally, the first device for detecting a first air pressure prevalent within the air chamber, in particular the first pressure sensor, can be removed from the spray gun. The data processing device is programmed in such a manner that said data processing device, as soon as the device for detecting a second air pressure prevalent outside the air chamber, in particular the second pressure sensor, detects a value for the air pressure, does not emit the detected value but the value for the air pressure corrected by the variance, said corrected value then being displayed by a device for displaying an air pressure described in more detail hereunder. As a result, the air pressure prevalent in the air chamber is displayed, despite the air pressure having been measured at another location in the spray gun.

Obviously, as an alternative to the series of variances, or the characteristic line, respectively, it may be provided that only a standard deviation is taken into account. This means that it can be provided that the same value is always subtracted from or added to the by the device for detecting an air pressure prevalent outside the air chamber, so as to determine the air pressure prevalent within the air chamber.

Advantageous configurations are the subject matter of the dependent claims.

The spray gun according to the invention preferably furthermore has an air cap having a central opening, wherein the central opening conjointly with a front region of the material nozzle forms an annular gap for delivering air for atomizing a material to be sprayed, and wherein at least one air chamber is formed by the material nozzle and the air cap. The front region of the material nozzle is preferably designed as a hollow-cylindrical plug, but it may also be of a conical design, for example. The cavity is formed by an external face of the material nozzle and an internal face of the air cap. Besides the annular gap for delivering air for atomizing a material to be sprayed, the air cap can have further air outlet openings, in particular horn air or forming-air openings, respectively, which can be disposed in horns on the air cap and from which air for changing the shape of a spray jet, the so-called forming air, flows, and/or control openings which can be incorporated in the air cap so as to be next to the central opening in the air cap and from which air for transporting an atomized spray medium, in particular away from the spray gun and in the direction of an object to be coated, the so-called transport air, flows. Besides the air chamber formed by the material nozzle and the air cap, the spray gun can have further air chambers which are designed, for example, as bores in the horns of the air cap. The types of air can of course also fulfil further purposes than those mentioned, in particular the purpose of post-atomizing the spray jet.

At least one device for detecting an air pressure, in particular a pressure sensor, which wirelessly and/or by wire is connected and/or connectable to a device for controlling and/or feedback-controlling an air pressure, in particular a mechanical, electronic and/or electromechanical device for controlling and/or feedback-controlling an air pressure, and/or to a device for displaying an air pressure and/or to a data processing device is particularly preferably disposed in the air chamber, in particular on an internal face of the air cap and/or on an external face of the material nozzle.

The device for detecting an air pressure, in particular the pressure sensor, can be adhesively bonded or soldered to an internal face of the air cap and/or to an external face of the material nozzle, for example, and/or said device for detecting an air pressure, in particular the pressure sensor, can be incorporated in the internal face of the air cap and/or on the external face of the material nozzle in such a manner that the internal face of the air cap conjointly with the external face of the device for detecting an air pressure, in particular of the pressure sensor, substantially form a planar face, or the external face of the material nozzle conjointly with the external face of the device for detecting an air pressure, in particular of the pressure sensor, substantially form a planar face, respectively. That is to say that the device for detecting an air pressure, in particular the pressure sensor, preferably does not protrude beyond the internal face of the air cap, or the external face of the material nozzle, respectively. In this way, disturbances of the air flow that are caused by the device for detecting an air pressure, in particular the pressure sensor, can be avoided.

The device for controlling and/or feedback-controlling an air pressure, in particular the device for controlling an air pressure, can be designed by means of a simple mechanical rotary button, wherein the rotary button or a part disposed thereon mechanically engages in, for example protrudes into, an air duct and/or at least partially covers said air duct, in particular changes the flow cross section of said air duct. Control in the present case is in particular to be understood to be an analog control without feedback. An advantage of such a control lies in the simplicity of the latter, in particular in the simple and thus cost-effective construction of said control, which can also dispense with a measuring device. However, there has to be a manual response to malfunctions, for example to a drop in pressure.

In contrast, a device for controlling and/or feedback-controlling an air pressure designed as a device for feedback-controlling an air pressure can maintain the air pressure at a constant level by the system measuring the variable to be influenced, here the air pressure, and continuously comparing said variable with the desired target value. An actuator, which can be designed as part of the feedback-controlled device or as a separate part, acts on the control path in such a manner that the actual value corresponds to the target value. The actuator or actuators can presently be disposed in or on the spray gun; however, said actuator or actuators can also be disposed so as to be remote from the spray gun, for example in or on an air hose, or in or on a compressor. Valves, apertures or throttles, in particular those which can be opened and closed in a preferably stepless manner, may be expedient for the present application.

The device for controlling and/or feedback-controlling an air pressure is preferably designed as part of the spray gun and disposed on or in the latter, and the device for detecting an air pressure, in particular the pressure sensor, is wirelessly and/or by wire connected and/or connectable to said device for controlling and/or feedback-controlling an air pressure. However, it is also conceivable that the device for detecting an air pressure, in particular the pressure sensor, is wirelessly and/or by wire connected and/or connectable to a device for controlling and/or feedback-controlling an air pressure that is disposed so as to be remote from the spray gun.

The device for displaying an air pressure can display, for example, the target value and/or the actual value of an air pressure. The device for displaying an air pressure is preferably an electrical or electronic display, in particular a screen or a display, in particular an LCD or OLED display, which is particularly preferably disposed in the main body of the spray gun. This can however also be a mechanical or electromechanical display. The device for displaying an air pressure is preferably designed as part of the spray gun and disposed on or in the latter, and the device for detecting an air pressure, in particular the pressure sensor, is wirelessly and/or by wire connected and/or connectable to said device for displaying an air pressure. However, it is also conceivable that the device for detecting an air pressure, in particular the pressure sensor, is wirelessly and/or by wire connected and/or connectable to a device for displaying an air pressure that is disposed so as to be remote from the spray gun.

The data processing device, which can also be considered to be an evaluation unit, can be designed as a microprocessor or have a microprocessor, and/or said data processing device can be designed as a controller or have a controller. It can be an object of the data processing device to detect data or commands, in particular measured values, measured data or target values, to process said data or commands, and to optionally emit data, signals or similar. The data processing device can be designed in such a manner, for example, that said data processing device can utilize one or a plurality of characteristic lines described above, and in this way can determine, in particular compute, from an air pressure prevalent outside the air chamber, an air pressure prevalent within the air chamber.

The devices mentioned can be connected to one another, in particular connected to one another in a communicating manner. The communication between devices can take place, for example, by means of cables or wires or wirelessly, for example by radio, satellite, Bluetooth, WLAN, ZigBee, NFC, Wibree, WiMAX, LoRaWAN and/or IrDA.

The spray gun according to the invention preferably furthermore has at least one air duct for directing air, in particular compressed air, from an air inlet to an air outlet, wherein the spray gun furthermore has at least one device for detecting an air pressure, in particular a pressure sensor, which is disposed outside the air chamber, in particular within at least one air duct configured downstream of the air chamber and/or within a compressed air chamber which upstream of the air chamber is connected to an air duct, wherein the spray gun furthermore has a device for determining, in particular computing, the air pressure prevalent in the air chamber during the operation of the spray gun based on the air pressure value determined by the device for detecting an air pressure, in particular the pressure sensor.

The device for detecting an air pressure can in particular be designed like the pressure measuring device in the above-mentioned DE 10135104 C1 or in the above-mentioned DE 10 2009 020 194 A1, and be disposed in or on the spray gun like these pressure measuring devices. The pressure measuring devices described in the publications mentioned, depending on the embodiment, measure the gun input pressure or the air pressure in a pressurized chamber close to the air valve which is activatable by means of the trigger. The air pressure in this pressurized chamber however does not equal the pressure in the air chamber, but a pressure difference is present.

The device for determining, in particular computing, the air pressure prevalent in the air chamber during the operation of the spray gun based on the air pressure value determined by the device for detecting an air pressure, in particular the pressure sensor, the spray gun according to the invention preferably having this device, takes into account this pressure difference. The device mentioned can be designed like the data processing device, or evaluation unit, respectively, described above and/or function like said data processing device or evaluation unit, respectively. Like the data processing device, at least one of the variances described above and/or at least one of the characteristic lines described above can be stored in the device and said device can be programmed in such a manner that the latter, from the air pressure determined by the device just mentioned for detecting an air pressure, which is disposed outside the air chamber and measures an air pressure within the spray gun but outside the air chamber, determines, in particular computes, the air pressure within the air chamber, preferably as a function of the value of the air pressure outside the air chamber and/or as a function of the nozzle inserted, or of the nozzle set inserted, respectively.

The device mentioned for detecting an air pressure and the device for determining, in particular computing, the air pressure prevalent in the air chamber during the operation of the spray gun based on the air pressure value determined by the device for detecting an air pressure, in particular the pressure sensor, are connected to one another, in particular connected to one another in a communicating manner. The communication between the devices can take place, for example, by means of cables or wires or wirelessly, for example by radio, satellite, Bluetooth, WLAN, ZigBee, NFC, Wibree, WiMAX, LoRaWAN and/or IrDA.

The spray gun according to the invention preferably has at least one device for determining, in particular computing, the air pressure prevalent in the air chamber during the operation of the spray gun and at least one replaceable component, in particular a replaceable nozzle assembly, in particular a replaceable material nozzle and/or a replaceable air nozzle, wherein the device for determining, in particular computing, the air pressure prevalent in the air chamber during the operation of the spray gun is designed in such a manner that the determination, in particular computation, of the air pressure prevalent in the air chamber during the operation of the spray gun is determined, in particular computed, as a function of at least one parameter of the replaceable component, in particular of the replaceable nozzle assembly, in particular of the type of the replaceable component, in particular of the replaceable nozzle assembly, and/or of at least one dimension of the replaceable component, in particular of the replaceable nozzle assembly, in particular of at least one internal and/or external diameter of an opening in the nozzle assembly. The explanations above pertaining to the variance between the air pressure within the air chamber and the air pressure outside the air chamber as a function of other factors, for example of the material nozzle used and/or of the air nozzle used, can likewise apply here. The device for determining, in particular computing, the air pressure prevalent in the air chamber during the operation of the spray gun is particularly preferably the above-mentioned device for determining, in particular computing, the air pressure prevalent in the air chamber during the operation of the spray gun based on the air pressure value determined by the device for detecting an air pressure, in particular the pressure sensor.

The spray gun according to the invention preferably has at least one replaceable component, in particular a replaceable nozzle assembly, in particular a replaceable material nozzle and/or a replaceable air nozzle, and at least one device for detecting an item of information, in particular an item of information pertaining to a type and/or to a dimension of the component disposed in the spray gun, in particular a nozzle size, and/or is wirelessly and/or by wire connected and/or connectable to a device of this type.

The device for detecting an item of information is preferably part of the spray gun and disposed in or on the latter, respectively.

The device for detecting an item of information can be designed as a manual input device, for example as a keyboard, a touch display, a rotary button, an array of buttons, or a selector lever or said device can have means of this type. However, the device for detecting an item of information can also be designed as an identification and/or data detection apparatus, such as a barcode scanner or RFID scanner, for example. In the latter case, the replaceable component, in particular the replaceable nozzle assembly, in particular the replaceable material nozzle and/or the replaceable air nozzle, can have a barcode, in particular a simple barcode or a QR code, or an RFID chip or another characterization and/or identification means which can be detected, in particular scanned, by the device for detecting an item of information. The device for detecting an item of information can be designed as part of the device for determining, in particular computing, the air pressure prevalent in the air chamber during the operation of the spray gun or be connected to the latter, in particular be connected to the latter in a communicating manner by wire and/or wirelessly. The items of information detected by the device for detecting an item of information can be used for determining, in particular computing, the air pressure prevalent in the air chamber during the operation of the spray gun based on the air pressure value determined by the device for detecting an air pressure, in particular the pressure sensor. As has already been described above, recorded variances, series of variances and/or characteristic lines can be linked to an item of information pertaining to the inserted nozzle or the inserted nozzle set. Depending on the item of information which has been detected by the device for detecting an item of information, another variance, series of variances and/or characteristic line can be used for determining, in particular computing, the air pressure prevalent in the air chamber during the operation of the spray gun, for example. For example, the manufacturer of the spray gun has installed a specific nozzle set in the spray gun, has recorded an above-described characteristic line with said specific nozzle set and linked the characteristic line to the type of the installed nozzle set. If the user of the spray gun uses the spray gun with this nozzle set, the device for detecting an item of information identifies this type of nozzle set or the user enters the type of the nozzle set in the device for detecting an item of information, respectively, whereupon a device for determining, in particular computing, the air pressure prevalent in the air chamber during the operation of the spray gun that is connected to the device for detecting an item of information, or a data processing device, or an evaluation unit, respectively, uses the characteristic line linked to this type of nozzle set as a basis for determining, in particular computing, the air pressure prevalent in the air chamber during the operation of the spray gun based on a detected air pressure prevalent outside the air chamber in the spray gun.

The device for detecting an item of information can also be considered to be a device for identifying the component disposed in the spray gun.

As above, the communication between the devices can also take place here, for example, by means of cables or wires or wirelessly, for example by radio, satellite, Bluetooth, WLAN, ZigBee, NFC, Wibree, WiMAX, LoRaWAN and/or IrDA.

The spray gun according to the invention preferably has at least one device for feedback-controlling and/or delimiting the air pressure prevalent in the air chamber during the operation of the spray gun and/or is wirelessly and/or by wire connected and/or connectable to a device of this type.

The device for feedback-controlling and/or delimiting the air pressure prevalent in the air chamber during the operation of the air gun is preferably part of the spray gun and disposed in or on the latter, respectively.

The spray gun according to the invention and/or the device for feedback-controlling and/or delimiting the air pressure prevalent in the air chamber during the operation of the spray gun can have at least one device for entering a target value and/or a minimum value and/or a maximum value for the air pressure prevalent in the air chamber during the operation of the spray gun and/or can be wirelessly and/or by wire connected and/or connectable to a device of this type. A target value, a minimum value and/or a maximum value for the air pressure prevalent in the air chamber can be established, or be communicated to a feedback-controlled device, respectively, using the device for entering a target value and/or a minimum value and/or a maximum value. A device for detecting at least one air pressure measures the actual value of the air pressure, in particular of the air pressure for which a target value has been established.

The device for feedback-controlling and/or delimiting the air pressure prevalent in the air chamber during the operation of the spray gun preferably has at least one actuator or is connected to at least one actuator so as to be able to adjust the air pressure. It is conceivable that the manufacturer specifies a fixed maximum value for the air pressure prevalent in the air chamber, for example the maximum permissible internal nozzle pressure of 0.7 bar (10 psi) for HVLP spray guns.

The spray gun according to the invention preferably has at least one device for emitting a signal, in particular an optical, acoustic and/or haptic signal, which is connected and/or connectable to a device for determining, in particular computing, the air pressure prevalent in the air chamber during the operation of the spray gun, to a device for controlling and/or feedback-controlling and/or delimiting an air pressure, to a device for displaying an air pressure and/or to a data processing device. If the air pressure drops below a specific value, exceeds a specific value or if intense pressure variations are detected, a warning signal, for example a warning sound or a warning light, can be emitted by means of the device for emitting a signal, for example.

As above, the communication between the devices can also take place here, for example, by means of cables or wires or wirelessly, for example by radio, satellite, Bluetooth, WLAN, ZigBee, NFC, Wibree, WiMAX, LoRaWAN and/or IrDA.

The spray gun according to the invention preferably has at least one nozzle assembly having at least one air nozzle, in particular an air nozzle having an air cap, wherein the air nozzle has at least one first outlet opening, in particular a central opening, for exhausting atomization air and at least one second outlet opening, in particular at least two second outlet openings, in particular forming-air openings, for exhausting forming air, wherein at least one first device for detecting an air pressure is disposed in the region of the first outlet opening of the air nozzle, in particular in the region of the central opening, and/or wherein at least one second device for detecting an air pressure is disposed in the region of the second outlet opening of the air nozzle, in particular in the region of at least one forming-air opening. In this way, the air pressure which co-decides the quality of the atomization and the painting result in general can be detected, in particular measured, in an ideally precise manner in the immediate proximity of the air outlet openings.

One preferred exemplary embodiment of a pressure measuring device according to the invention has a device for detecting an item of information, in particular pertaining to a manufacturer and/or a model of a spray gun, a type and/or a dimension of a component disposed in a spray gun, in particular a nozzle size, and/or by wire and/or wirelessly is connected and/or connectable to a device of this type.

The explanations above relating to the device for detecting an item of information, which the spray gun according to the invention can have, likewise apply to the present device for detecting an item of information. Furthermore, the present device as additional items of information can detect the manufacturer and/or the model of a spray gun. This can take place either manually or automatically when disposing the pressure measuring device on a spray gun. For example, contacts which enable the transfer of information can engage on one another when the pressure measuring device is disposed on a spray gun.

The pressure measuring device according to the invention preferably has at least one display device, in particular for displaying a pressure value. This is particularly preferably a display, in particular an LCD or OLED display.

The pressure measuring device according to the invention preferably has at least one device for emitting a signal, in particular an optical, acoustic and/or haptic signal, which is connected and/or connectable to a device for determining, in particular computing, the air pressure prevalent in the air chamber during the operation of the spray gun, to a device for controlling and/or feedback-controlling and/or delimiting an air pressure, to a device for displaying an air pressure and/or to a data processing device. The explanations above relating to the device for emitting a signal, which the spray gun according to the invention can have, likewise apply to the present device.

The method according to the invention, as at least one further step, can comprise designing a pressure measuring device for the spray gun, wherein the pressure measuring device is designed in such a manner that said pressure measuring device takes into account, in particular takes into account mathematically, the variance between a first air pressure at the first position within the spray gun and a second air pressure at the second position within the spray gun. The method according to the invention particularly preferably comprises at least disposing the pressure measuring device, in particular the pressure sensor, at the second position. Reference is made to the explanations above relating to the taking into account of variances and the disposing of a pressure measuring device.

The invention will be explained in more detail in an exemplary manner hereunder by means of three figures, in which:

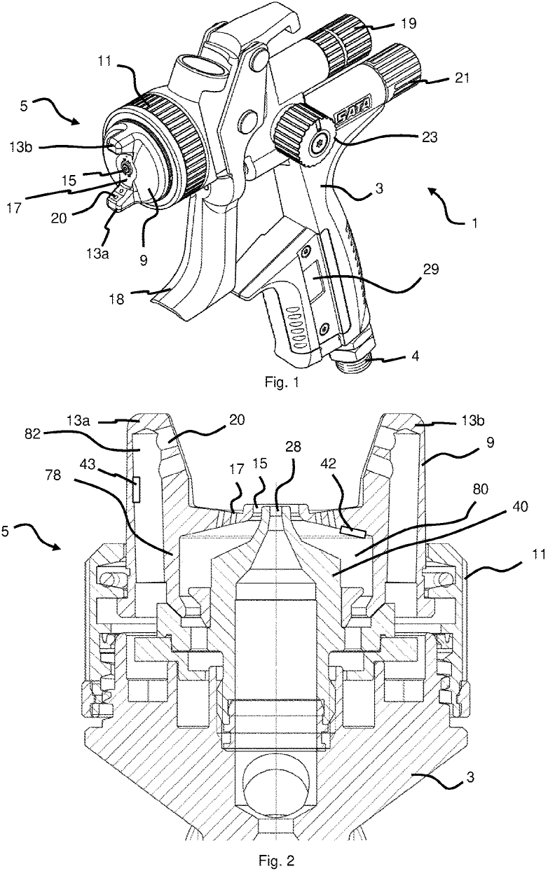

FIG. 1 shows a perspective view of an exemplary embodiment of a spray gun according to the invention,

FIG. 2 shows a sectional view of the head region of an exemplary embodiment of a spray gun according to the invention, and

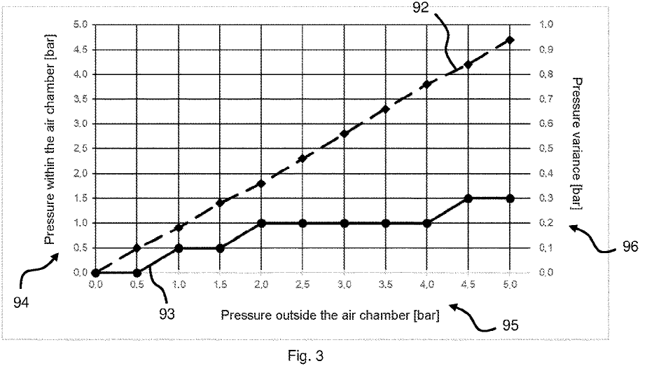

FIG. 3 shows a diagram with an example of a characteristic line which shows the air pressure within an air chamber plotted over the air pressure outside an air chamber, as well as of a characteristic line which shows the variance between the air pressure outside an air chamber and the air pressure within an air chamber plotted over the air pressure outside an air chamber.

FIG. 1 shows a perspective view of an exemplary embodiment of a spray gun 1 according to the invention, having a main body 3, an air inlet 4 being disposed on the lower end of said main body 3. The spray gun 1 furthermore has an air nozzle 5 which presently comprises an air cap 9 which by means of an air nozzle ring 11 is screwed onto the main body 3 of the spray gun 1. The air cap 9 in the exemplary embodiment shown has two horns 13a, 13b having in each case two horn air openings. Moreover, said air cap 9 possesses a central opening 15 which presently, conjointly with a material nozzle screwed into the main body 3, forms an annular gap. A plurality of control openings 17 are in each case incorporated onto two mutually opposite sides of the central opening 15 so as to be next to the central opening 15. A material quantity control which is able to be activated by way of a material quantity rotary control button 19 is disposed in the spray gun 1. A rear detent for a paint needle is able to be defined by way of the material quantity control, i.e. it can be adjusted by way of the material quantity control how far the paint needle can exit the material outlet opening of the material nozzle when the trigger 18 is activated. As a result, the maximum flow cross section for the material flowing out of the material outlet opening of the material nozzle, and thus the quantity of the material sprayed by the spray gun 1, is defined.

The spray gun 1 moreover has a device by way of which the quantity of air which, from an air inlet duct assembly which is not visible in FIG. 1 and extends upward from the air inlet 4 through the handle of the spray gun 1, flows into an upper part of the gun body 3 is able to be adjusted. To this end, a so-called air micrometer can be used, which presently is able to be activated by means of an air micrometer rotary button 21. The air micrometer can be designed as a sleeve, for example, which in the wall thereof has an opening, the degree of overlap of said opening with the port of the air inlet duct assembly being able to be adjusted. The flow cross section through which the air from the handle region of the spray gun 1 can flow into an upper part of the gun body 3 is able to be adjusted in this way.

The present exemplary embodiment of a spray gun 1 according to the invention in the interior thereof has a first air outlet duct assembly, not visible in FIG. 1, and a second air outlet duct assembly, likewise not visible in FIG. 1. The first air outlet duct assembly can in particular be an air outlet duct assembly for directing air for the atomization of a material to be sprayed. This air outlet duct assembly can be referred to as an atomization air duct assembly or as an atomization air duct. The air directed by said duct assembly or duct can flow out of the annular gap which is formed by the central opening 15 and by the material nozzle screwed into the main body 3 and said air can be referred to as atomization air. The second air outlet duct assembly can in particular be an air outlet duct assembly for directing air for changing the shape of a spray jet. This air outlet duct assembly can be referred to as a forming-air duct assembly or as a forming-air duct. The air directed by said duct assembly or duct can flow out of the forming-air openings 20 of the horns 13a, 13b and be referred to as forming air. Visible in FIG. 1 is a round-broad jet rotary button 23 for activating a control device for distributing between the atomization air duct assembly and the forming-air duct assembly the air flowing out of the air inlet duct assembly.

The spray gun 1 moreover has a device for entering and/or adjusting and/or detecting and/or determining and/or displaying the air pressure prevalent in an air chamber during the operation of the spray gun 1, said device having a display 29. In the present exemplary embodiment, this is a device for determining and displaying the air pressure prevalent in an air chamber during the operation of the spray gun, said device furthermore having a device for detecting an air pressure, in particular a pressure sensor.

The device for detecting an air pressure, in particular the pressure sensor, presently detects, in particular measures, the air pressure in a pressurized chamber close to the air valve which is able to be activated by means of the trigger 18. The device for determining the air pressure prevalent in an air chamber during the operation of the spray gun 1 determines, in particular computes, from this measured compressed air value at a position outside the air chamber that upstream is adjacent to at least one air outlet opening, the air pressure prevalent in the air chamber during the operation of the spray gun 1. This takes place by means of the above-described taking into account of a known variance and/or series of variances between the air pressure values stored in the device for determining the air pressure prevalent in the air chamber during the operation of the spray gun 1 and/or an above-described characteristic line stored in this device.

The device for displaying the air pressure prevalent in the air chamber during the operation of the spray gun by means of the display 29 preferably displays the air pressure prevalent in the air chamber during the operation of the spray gun 1.

However, the spray gun 1 can also have a device for detecting an air pressure, in particular a pressure sensor, which is disposed in the air chamber and is connected wirelessly and/or by wire to a device for controlling and/or feedback-controlling an air pressure and/or to a device for displaying an air pressure and/or to a data processing device. The device for detecting an air pressure, in particular the pressure sensor, can be disposed within the air chamber and directly detect, in particular measure, the air pressure prevalent in the air chamber during the operation of the spray gun 1, and transmit said air pressure to a device for displaying an air pressure, for example, to which the device for detecting an air pressure, in particular the pressure sensor, is preferably wirelessly connected. In this way, the air pressure prevalent in the air chamber during the operation of the spray gun 1 can be displayed by the display 29, for example.

FIG. 2 shows a sectional view of the head region of an exemplary embodiment of a spray gun according to the invention. An air nozzle 5 which presently has an air cap 9 and an air nozzle ring 11 is disposed on the head region of the main body 3. The air cap 9 has two horns 13a, 13b and a plurality of air outlet openings, specifically a central opening 15, a plurality of control openings 17, and in each case two forming-air openings 20 in the horn 13a and in the horn 13b. A material nozzle 40 which is screwed into the main body 3 of the spray gun 1 has a material outlet opening 28. The front end of the material nozzle 40, conjointly with the central opening 15, forms an annular gap for exhausting atomization air. The material nozzle 40 and the air cap 9 form a first air chamber 80. This here is one of the air chambers of which the air pressure prevalent therein is of particular interest in the present case. A first device for detecting an air pressure 42 is disposed in the air chamber 80, in the present exemplary embodiment on an internal face of the air cap 9. The first device for detecting an air pressure 42 is partially sunk into the air cap 9. However, said first device can also be incorporated in the air cap 9 in such a manner that the internal face of the air cap 9 and the external face of the device for detecting an air pressure 42 form a planar face without steps.

A second air chamber 82, the air pressure prevalent therein likewise being of interest in the present case, is designed as a bore in the horn 13a. A second device for detecting an air pressure 43 is disposed in said second air chamber 82. The horn 13b likewise has an air chamber designed as a bore, but in the present case no device for detecting an air pressure. By virtue of the symmetrical arrangement of the two horns 13a, 13b, and because the latter are supplied with air from the same forming-air duct assembly, it is usually not necessary for a device for detecting an air pressure to be disposed in both horns 13a, 13b, since the pressure in the two horns 13a, 13b is usually identical. Of course, it is however also possible for devices for detecting an air pressure to be disposed in both air chambers of the horns 13a, 13b.

During the operation of the spray gun, atomization air, which flows from an atomization air duct assembly in the main body 3 of the spray gun 1 into the first air chamber 80, flows through the annular gap formed by the front end of the material nozzle 40 having the central opening 15. As a result, the atomization air in the first air chamber 80 generates an air pressure, the value of the latter presently being of interest. If air is directed into the forming-air duct assembly in the main body 3 of the spray gun 1, in particular by way of a round-broad jet control which is able to be operated by the user of the spray gun 1 by way of a round-broad jet rotary button 21 shown in FIG. 1, this forming air flows from the forming-air duct assembly into the second air chamber 82 and from there through the forming-air openings 20. As a result, the forming air in the second air chamber 82 generates an air pressure which may likewise be of interest. The value measured by the first device for detecting an air pressure 42 and/or by the second device for detecting an air pressure 43 can be sent to a device for controlling and/or feedback-controlling an air pressure and/or to a device for displaying an air pressure and/or to a data processing device, for example. In the simplest case, the pressure value is sent to a device for displaying an air pressure, whereupon the pressure value is displayed on a display 29 shown in FIG. 1, for example.

FIG. 3 by way of example shows a first characteristic line 92 which shows the air pressure within an air chamber being plotted over the air pressure outside an air chamber. The air pressure within an air chamber has been plotted along the vertical primary axis 94; the air pressure outside an air chamber has been plotted along the horizontal axis 95. The first characteristic line 92 shows which air pressure is prevalent within an air chamber at which air pressure outside the air chamber. For example, it can be seen that at a pressure outside the air chamber of 0.5 bar, a pressure of 0.5 bar is also prevalent within the air chamber. At a pressure of 2.5 bar outside the air chamber, a pressure of only 2.3 bar is prevalent within the pressurized chamber. At a pressure of 5.0 bar outside the air chamber, a pressure of only 4.7 bar is prevalent within the pressurized chamber.

The second characteristic line 93 shows the variance between the air pressure outside an air chamber and the air pressure within an air chamber plotted over the air pressure outside an air chamber. The variance in the present case has been computed from the difference between the air pressure outside an air chamber and the air pressure within an air chamber. The variance has been plotted along the vertical secondary axis 96; the air pressure outside an air chamber has been plotted along the horizontal axis 95. It is apparent that the variance increases as the air pressure outside the air chamber increases. In reality, the variance does not increase in steps as is shown in the diagram, but a continuous increase is rather to be assumed. The stepped shape of the increase is due to the spacing between the points of measurement and due to the rounding of measured values.

In general, the components mentioned individually in the exemplary embodiments can be used in all exemplary embodiments. The explanations pertaining to the exemplary embodiments can also apply to all exemplary embodiments. The explanations pertaining to the spray gun according to the invention can also apply to the pressure measuring device according to the invention and to the method according to the invention; the explanations pertaining to the pressure measuring device according to the invention can also apply to the spray gun according to the invention and to the method according to the invention; the explanations pertaining to the method according to the invention can also apply to the spray gun according to the invention and to the pressure measuring device according to the invention.

The described exemplary embodiments describe only a limited selection of potential embodiments and thus do not represent any limitation of the present invention.

1-17. (canceled)

18. A spray gun having at least one material nozzle for delivering a material to be sprayed, at least one air nozzle for delivering air, at least one air chamber which upstream is adjacent to the at least one air nozzle or to at least one air outlet opening of the at least one air nozzle, for supplying the at least one air nozzle with air, and at least one device for entering and/or adjusting and/or detecting and/or determining and/or displaying air pressure prevalent in the at least one air chamber during operation of the spray gun.

19. The spray gun of claim 18, wherein the spray gun further comprises an air cap having a central opening, wherein the central opening conjointly with a front region of the at least one material nozzle forms an annular gap for delivering air for atomizing a material to be sprayed, and wherein at least one air chamber is formed by the at least one material nozzle and the air cap.

20. The spray gun of claim 18, wherein at least one device for detecting an air pressure which wirelessly and/or by wire is connected and/or connectable to a device for controlling and/or feedback-controlling an air pressure and/or to a device for displaying an air pressure and/or to a data processing device is disposed in the at least one air chamber on an internal face of the air cap and/or on an external face of the at least one material nozzle.

21. The spray gun of claim 18, wherein the spray gun further comprises:
at least one air duct for directing air from an air inlet to an air outlet,
at least one device for detecting an air pressure which is disposed outside the at least one air chamber, and
a device for determining the air pressure prevalent in the at least one air chamber during operation of the spray gun based on the air pressure value determined by the device for detecting an air pressure.

22. The spray gun of claim 18, wherein the spray gun has at least one device for determining the air pressure prevalent in the at least one air chamber during operation of the spray gun and at least one replaceable component including a replaceable material nozzle and/or a replaceable air nozzle, wherein the device for determining the air pressure prevalent in the at least one air chamber during operation of the spray gun is designed such that the determination of the air pressure prevalent in the at least one air chamber during operation of the spray gun is determined as a function of at least one parameter of the replaceable component and/or of at least one dimension of the replaceable component.

23. The spray gun of claim 18, wherein the spray gun has at least one replaceable component including at least one of a replaceable nozzle assembly, a replaceable material nozzle and/or a replaceable air nozzle, and at least one device for detecting an item of information pertaining to a type and/or to a dimension of the component disposed in the spray gun and/or is wirelessly and/or by wire connected and/or connectable to a device of this type.

24. The spray gun of claim 18, wherein the spray gun has at least one device for feedback-controlling and/or delimiting the air pressure prevalent in the at least one air chamber during operation of the spray gun and/or is wirelessly and/or by wire connected and/or connectable to a device of this type.

25. The spray gun of claim 18, wherein the spray gun has at least one device for entering a target value and/or a minimum value and/or a maximum value for the air pressure prevalent in the air chamber during operation of the spray gun and/or is wirelessly and/or by wire connected and/or connectable to a device of this type.

26. The spray gun of claim 18, wherein the spray gun has at least one device for emitting a signal which is connected and/or connectable to a device for determining the air pressure prevalent in the at least one air chamber during operation of the spray gun, to a device for controlling and/or feedback-controlling and/or delimiting an air pressure, to a device for displaying an air pressure and/or to a data processing device.

27. The spray gun of claim 18, wherein the spray gun has at least one nozzle assembly having at least one air nozzle having an air cap, wherein the air nozzle has at least one first outlet opening for exhausting atomization air and at least one second outlet opening for exhausting forming air, wherein at least one first device for detecting an air pressure is disposed in the region of the first outlet opening of the air nozzle, and/or wherein at least one second device for detecting an air pressure is disposed in the region of the second outlet opening of the air nozzle.

28. A pressure measuring device for a spray gun having at least one material nozzle for delivering a material to be sprayed, at least one air nozzle for delivering air, at least one air chamber for supplying the at least one air nozzle with air, at least one air duct for directing air from an air inlet to the at least one air nozzle, the pressure measuring device comprising:
at least one device for detecting an air pressure, wherein the pressure measuring device is fastened or fastenable to the spray gun such that the pressure measuring device is connected to the at least one air duct,
a device for determining the air pressure prevalent in the at least one air chamber during operation of the spray gun based on the air pressure value determined by the device for detecting an air pressure.

29. The pressure measuring device of claim 28, wherein the pressure measuring device has a device for detecting an item of information pertaining to a spray gun, to a type and/or a dimension of a component disposed in the spray gun and/or is wirelessly and/or by wire connected and/or connectable to the item of information detecting device.

30. The pressure measuring device of claim 28, wherein the pressure measuring device has at least one display device for displaying a pressure value.

31. The pressure measuring device of claim 28, wherein the pressure measuring device has at least one device for emitting a signal which is connected and/or connectable to a device for determining the air pressure prevalent in the air chamber during operation of the spray gun, to a device for controlling and/or feedback-controlling and/or delimiting an air pressure, to a device for displaying an air pressure and/or to a data processing device.

32. A method for designing the spray gun of claim 21, the method comprising:
determining a variance between a first air pressure, which is prevalent at a first position within the spray gun during operation of the spray gun, and a second air pressure, which is prevalent at a second position within the spray gun during the operation of the spray gun,
wherein the first position is situated within the air chamber, and
wherein the second position is situated outside the air chamber.

33. The method of claim 32, further comprising:
designing a pressure measuring device for the spray gun, wherein the pressure measuring device is designed such that the pressure measuring device takes into account the variance between the first air pressure at the first position within the spray gun and the second air pressure at the second position within the spray gun.

34. The method of claim 32, further comprising:
disposing the pressure measuring device at the second position.
